(19) United States
(12) Patent Application Publication
(10) Pub. No.: US 2016/0217527 A1
(43) Pub. Date: Jul. 28, 2016

(54) Strategy Management Tool With Multiple Lean Techniques

(71) Applicant: TRADING TECHNOLOGIES INTERNATIONAL INC., CHICAGO, IL (US)

(72) Inventors: Jason SHAFFER, Chicago, IL (US); Sun Joong YOO, Chicago, IL (US)

(21) Appl. No.: 14/607,829

(22) Filed: Jan. 28, 2015

(51) Int. Cl. G06Q 40/04

(52) U.S. Cl. CPC G06Q 40/04

(57) ABSTRACT

Systems and methods to define and implement a spread trading strategy having multiple lean legs are described. An example method includes receiving, via a computing device, a definition of a spread trading strategy. The definition includes a first leg associated with a first tradeable object, a second leg associated with a second tradeable object and a third leg associated with a third tradeable object. The example method includes determining, via the computing device, a first leg price for the first leg using a first lean pricing technique and determining, via the computing device, a second leg price for the second leg using a second lean pricing technique. The second lean pricing technique is different than the first lean pricing technique. The example method also includes calculating, via the computing device, a quote price for the third leg based on the first leg price, the second leg price and a desired spread trading strategy price and submitting, via the computing device, a quote order for the third leg at the quote price.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

Once connected to the electronic exchange via their trading devices, traders may select which tradeable object the traders wish to trade. Traders may utilize automated or semi-automated trading tools that automatically or semi-automatically send orders from their trading device to the electronic exchange. Such automated tools are usually provided, among other things, to facilitate fast and accurate order entry. Traders may utilize automated tools that are configured to implement trading strategies to direct transactions involving the purchase and sale of one or more tradeable objects.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy, which may be employed with certain disclosed embodiments.

FIG. 5 illustrates an example trading strategy or spread trading strategy configuration window to enable a trader to define a spread trading strategy having multiple lean legs.

FIG. 6 illustrates block diagrams of example trading interfaces including an example spread window, an example quoting leg window and example lean leg windows for the lean legs of the spread trading strategy configured in the example configuration window of FIG. 5.

FIGS. 7A and 7B illustrate a flow diagram for an example method or process to define and implement a spread trading strategy having multiple lean legs.

FIG. 8 illustrates a block diagram of an example spread trading strategy system that can implement and/or execute the example method of FIGS. 7A and 7B and which can be used to implement the example spread trading strategy configuration window of FIG. 5 and/or the example trading interfaces of FIG. 6.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to strategy trading and, more particularly, to tools and mechanisms for managing strategy trading such as a spread trading strategy having multiple lean legs.

A trading strategy such as a spreading strategy defines a relationship between two or more tradeable objects to be traded. Each tradeable object being traded as part of a trading strategy may be referred to as a leg or outright market of the trading strategy. A trading strategy can involve buying tradeable objects, buying and selling tradeable objects, selling tradeable objects or some combination thereof.

In general, a trader inputs a price to buy or sell the spread, and an automated trading tool automatically works orders in the legs to achieve, or attempt to achieve the trader's desired price for the spread. For example, when a trader instructs the automated trading tool to buy or sell a trading strategy at a desired price, the automated trading tool automatically places an order for one of the tradable objects to achieve the desired price for the trading strategy. The leg for which the order is placed may be referred to as the quoting leg. The other leg may be referred to as a lean leg and/or a hedge leg. Once the order for the quoting leg is filled, the automated trading tool automatically places an order for the lean leg to complete the spread. Rapid placement of the lean or hedge leg reduces the trader's risk from holding an open or unhedged position. The price that the quoting leg is quoted at is based on a target price that an order can be filled at in the lean leg. The target price in the lean leg is also known as the leaned on price, lean price, lean order price and/or lean level. Typically, if there is sufficient quantity available, the target price may be the best bid price when selling and the best ask price when buying. As the leaned on price changes, the price for the order in the quoting leg may also change to maintain the desired strategy price. Once the order for the quoting leg is filled, the automated trading tool automatically places an order in lean leg to complete the trading strategy. In some instances, the price and/or available quantity in the lean leg changes and, if the price and/or available quantity changes too much, the order for the lean leg may not be able to be filled to complete the trading strategy. In this case, the trading strategy is said to be “legged up” or “legged.” Therefore, to avoid getting “legged,” the price that the quoting leg is quoted at is based on a lean price in the lean leg to ensure the lean leg can get filled.

In addition to having a single quoting leg and/or single leaning leg, a spread trading strategy may include multiple quoting legs and/or leaning legs. For example, a spread trading strategy may include one quoting leg and two lean legs. Similar to the quoting strategy described above, the price for which the quoting leg(s) is quoted at is based on the prices at which the lean leg(s) can be filled (e.g., for which there is sufficient quantity) and a desired spread trading strategy price. This conservative approach prices the quoting leg(s) based on relatively safe assumptions that the lean leg(s) can be filled once the quoting leg(s) are filled (e.g., in order to avoid getting “legged”). However, with such a conservative and rigid approach, there may be missed opportunities for achieving a better price for one or more of the legs of the trading strategy. For example, there may be one or more price levels between the best ask and the best bid, also known as a “gap” in the market, without quantities but which may present added opportunities to achieve a better offer or asking price for the trader. By leaning on a price within a gap, a trader may be able to get a more advantageous or desired price for the trading strategy. Further, because each of the different lean legs may be associated with a different tradeable object, each of the different lean legs may respond differently to market data. Thus, applying the same pricing logic for each of the lean legs may result in one or more missed opportunities for achieving a better offer or asking price for the trader.

The example systems and methods disclosed herein enable different lean pricing techniques to be applied to different lean legs of a spread trading strategy. In particular, the example systems and methods enable a trader to select different lean pricing techniques for pricing the different lean legs of a trading strategy. As a result, a trader can create more complex, custom and targeted trading strategies that enable the trader to capitalize on factors such as the trader's knowledge of the market, volume being traded, market fluctuations and/or the trader's own personal experiences and preferences.

Disclosed herein is an example spread trading strategy configuration window (e.g., for use with a trading tool or trading application) that allows a user to select lean pricing techniques on a per-leg basis. In some examples, a plurality of lean pricing techniques are presented to the user and the user may select which lean pricing technique to apply to each of the lean legs. In some examples, certain lean pricing techniques include addition parameters than may be used to further define the functions of the lean pricing technique. The example configuration window may present the parameters to the user and the user may modify the parameters affecting the lean pricing technique.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

An embodiment disclosed herein provides a method that includes receiving, via a computing device, a definition of a spread trading strategy. The definition includes a first leg associated with a first tradeable object, a second leg associated with a second tradeable object and a third leg associated with a third tradeable object. The method of the embodiment includes determining, via the computing device, a first leg price for the first leg using a first lean pricing technique and determining, via the computing device, a second leg price for the second leg using a second lean pricing technique. The second lean pricing technique is different than the first lean pricing technique. The method of the embodiment also includes calculating, via the computing device, a quote price for the third leg based on the first leg price, the second leg price and a desired spread trading strategy price and submitting, via the computing device, a quote order for the third leg at the quote price.

Another embodiment disclosed herein provides a tangible computer readable storage medium comprising instructions that, when executed, cause a computing device to at least receive a definition of a spread trading strategy. The definition includes a first leg associated with a first tradeable object, a second leg associated with a second tradeable object and a third leg associated with a third tradeable object. The instructions of the tangible computer readable storage medium also cause, when executed, the computing device to determine a first leg price for the first leg using a first lean pricing technique and determine a second leg price for the second leg using a second lean pricing technique. The second lean pricing technique is different than the first lean pricing technique. The instructions of the tangible computer readable storage medium further cause, when executed, the computing device to calculate a quote price for the third leg based on the first leg price, the second leg price and a desired spread trading strategy price and submit a quote order for the third leg at the quote price.

An embodiment disclosed herein provides a system including a computing device configured to receive a definition of a spread trading strategy. The definition includes a first leg associated with a first tradeable object, a second leg associated with a second tradeable object and a third leg associated with a third tradeable object. The computing device is to determine a first leg price for the first leg using a first lean pricing technique and determine a second leg price for the second leg using a second lean pricing technique. The second lean pricing technique is different than the first lean pricing technique. The computing device is also to calculate a quote price for the third leg based on the first leg price, the second leg price and a desired spread trading strategy price and submit a quote order for the third leg at the quote price.

### II. Example Electronic Trading System

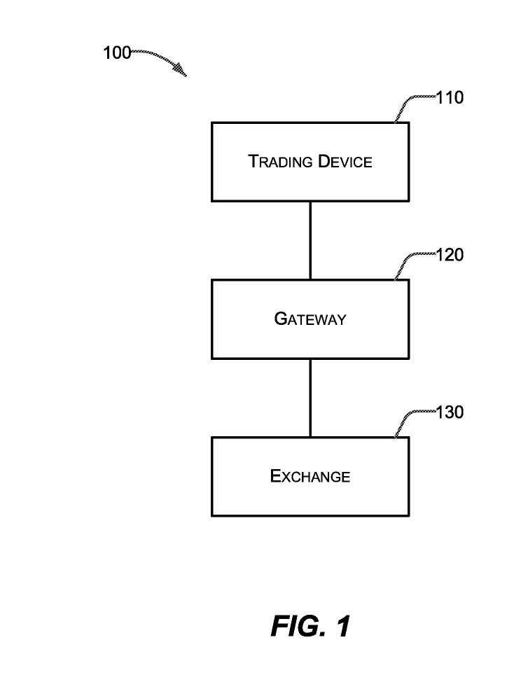

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device maybe executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

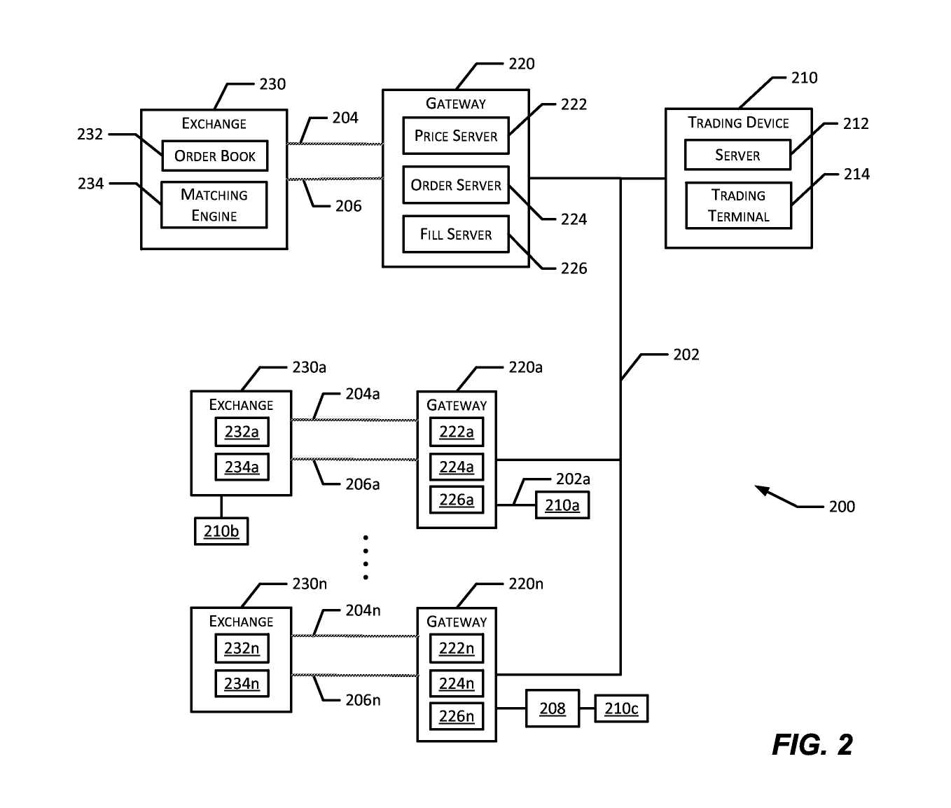

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234.The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

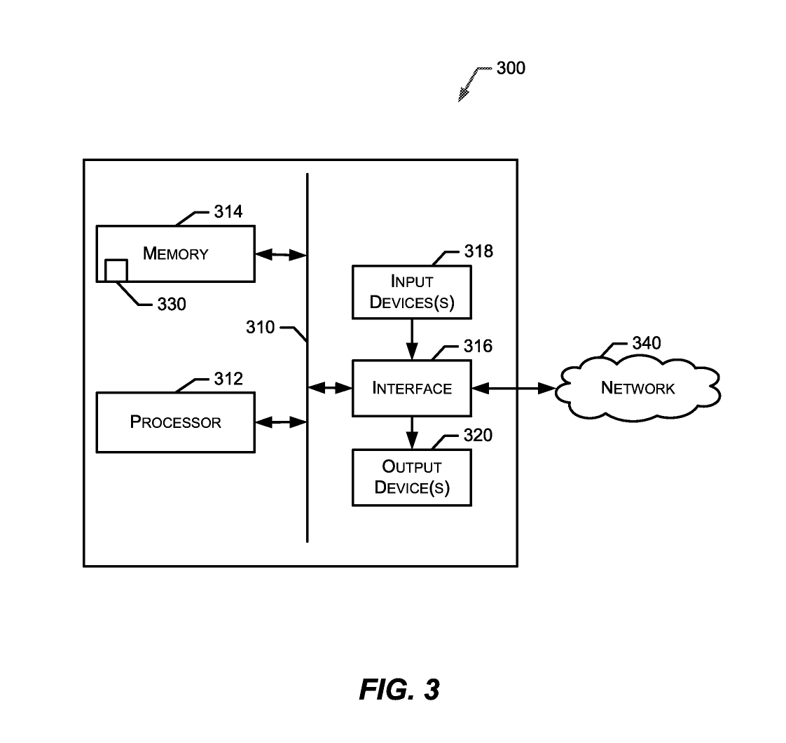

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy or spread trading strategy may also be referred to as spread trading. Spread trading may attempt to capitalize on changes or movements in the relationships between the tradeable object in the trading strategy, for example.

An automated trading tool may be utilized to trade according to a trading strategy, for example. For example, the automated trading tool may include AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

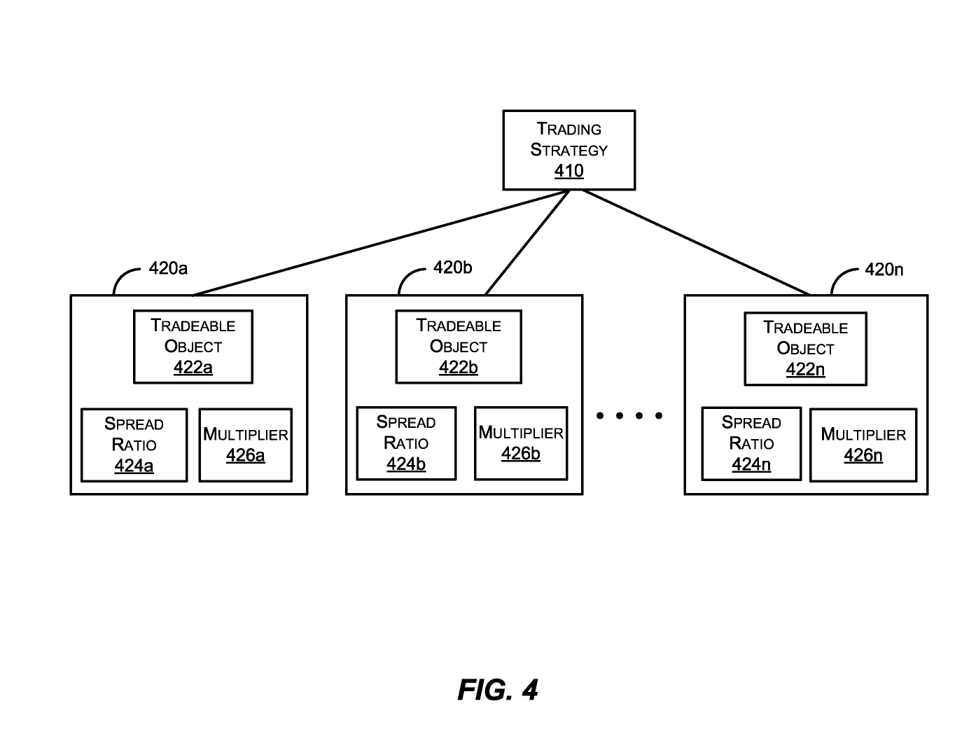

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420a-420n comprising the tradeable objects 422a-422n multiplied by corresponding multipliers 426a-426n. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order can be filled at in the lean leg. The target price in the hedge leg is also known as the leaned on price, lean price, lean order price and/or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available or, for example, an accumulated quantity of 15, including quantities from levels closer to the inside market. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Strategy Management Tool for Configuring a Spread Trading Strategy to Utilize Multiple Lean Techniques

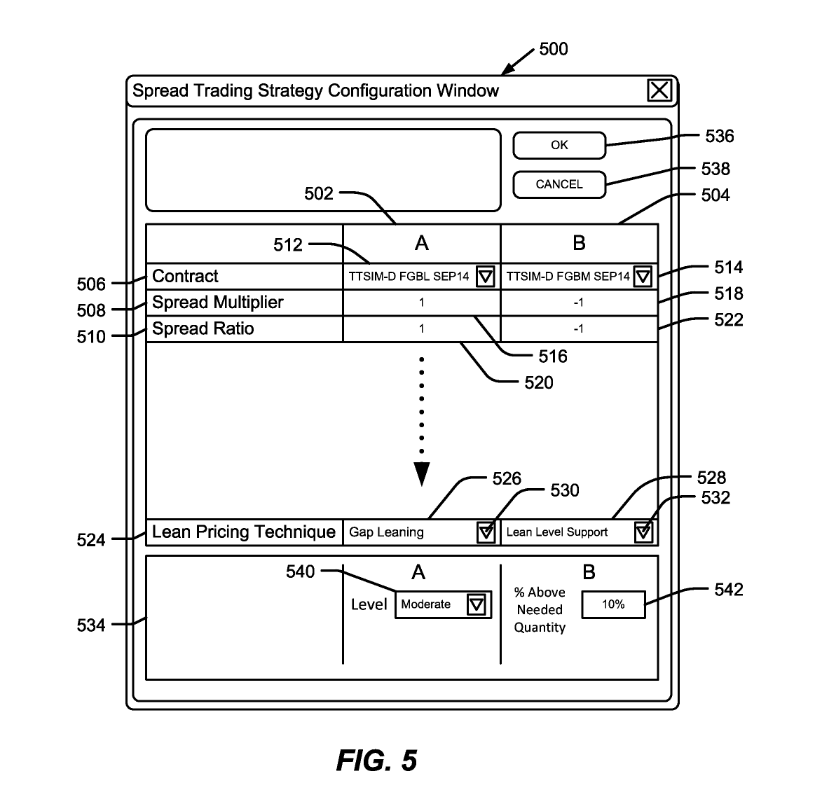

FIG. 5 illustrates an example interface 500 (e.g., a configuration pane, a parameter window, a spread manager window, a trading tool, etc.) that may be utilized by a trader to configure a spread trading strategy in which certain embodiments may be employed. The example configuration interface 500 may be displayed via a trading interface on, for example, the trading device 110 of FIG. 1 and/or the trading device 210 of FIG. 2 using a trading application including trading tools to process and/or organize market data. Trading tools may include, for example, MD TRADER®, X_TRADER®, ADL®, AUTOSPREADER®, and AUTOTRADER™, each provided by Trading Technologies. The trading devices 110, 210 provide a trading interface (e.g., a user interface) to enable a user to view market data and communicate trade orders, trade actions with an electronic exchange, define trading strategies, etc.

The example configuration interface 500 of FIG. 5 may be used to define a trading strategy or spread trading strategy such as the trading strategy 410 of FIG. 4. The trading strategy may have one or more quoting legs and one or more leaning legs. Each of the legs is associated with a tradeable object that is to be bought or sold as defined by the trading strategy. In the illustrated example, two lean legs have been added to the configuration interface 500. Specifically, a first lean leg 502 (leg “A”) and a second leaning leg 504 (leg “B”) have been selected as part of the trading strategy. The one or more quoting legs may be selected in another window or may also be defined in the configuration interface 500. Example systems and methods for configuring and/or defining spreads (e.g., using configuration windows in a trading interface) can be found in U.S. Pat. No. 7,437,325, titled “System and Method for Performing Automatic Spread Trading,” and filed May 3, 2002, which is hereby incorporated by reference in its entirety. In the illustrated example of FIG. 5, the first and second lean legs 502, 504 may correspond to, for example, two of the legs 420a to 420n of the trading strategy 410 in FIG. 4. Although only two lean legs are illustrated in the configuration interface 500, it is understood that any number of lean legs may be added to the configuration interface 500 (e.g., three lean legs, eight lean legs, fourteen lean legs, etc.) to define the trading strategy.

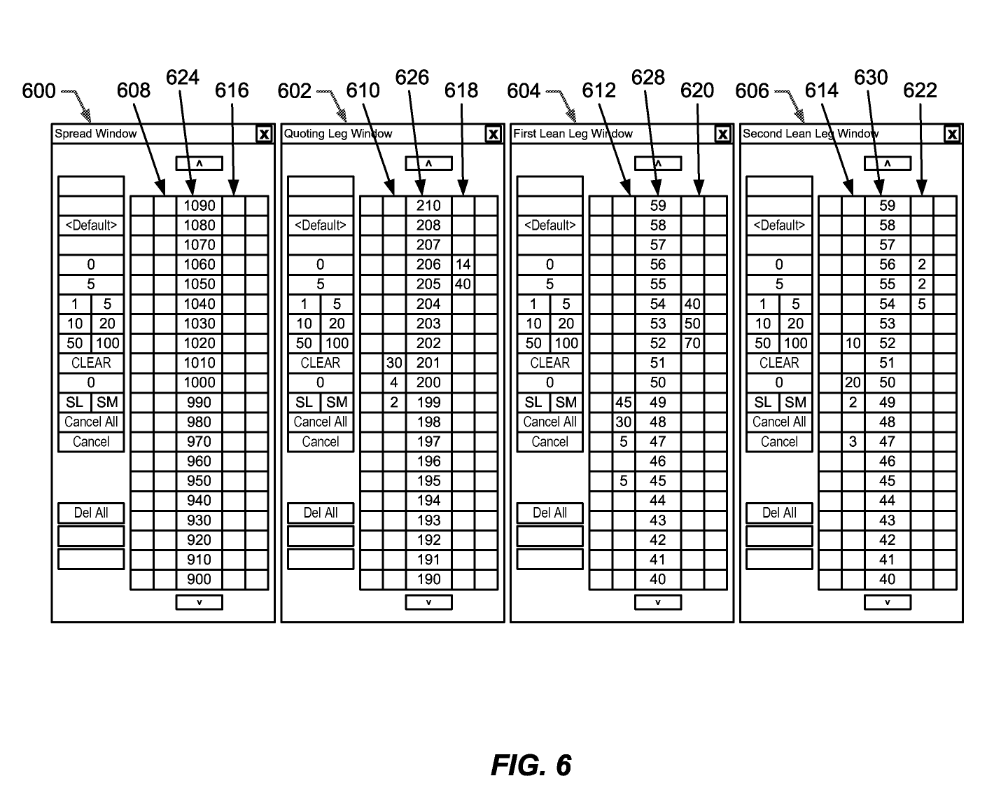

In the illustrated example, the configuration interface 500 has a plurality of spread setting parameters (e.g., categories, criteria, etc.) that can be set by a user to customize the spread data feed. The spread setting parameters may control the behavior of the spread as it is generated and/or displayed and/or traded, depending on the particular parameter. In the illustrated example, the categories of parameters include a contract name 506 (e.g., the tradeable object associated with the respective leg), a spread multiplier 508 and a spread ratio 510. In the illustrated example, the configuration interface 500 includes contract leg fields 512, 514 for specifying and/or identifying the name of the tradeable objects or contracts associated with the respective first and second lean legs 502, 504, spread multiplier fields 516, 518 for specifying and/or identifying the spread multipliers 508 for the respective first and second lean legs 502, 504 and spread ratio fields 520, 522 for specifying and/or identifying the spread ratios 510 for the respective first and second lean legs 502, 504. In other examples, more or fewer categories of spread setting parameters may be included. Other spread setting parameters may include, for example, customer account, active quoting, adjust for market depth, offset with, pay-up ticks, use cancel/replace rather than change and/or price reasonability check on leg. A description of these parameters can be found in U.S. Pat. No. 7,437,325. Additionally or alternatively, the example configuration interface 500 may include other setting categories of parameters such as those disclosed in connection with FIG. 6 in U.S. Pat. No. 7,437,325.

As described above, typically a desired price at which to buy or sell a particular trading strategy is determined. In particular, the price for the trading strategy is typically the sum of the price of the leg(s) comprising the tradeable objects multiplied by corresponding multiplier(s). Thus, using the lean price(s) for the lean leg(s) and the desired price of the spread, the quote price(s) (e.g., a quote order price) for the quoting leg(s) can be calculated. In current systems, the price at which the quoting leg(s) is quoted is based on a target price at which an order can be filled in the lean leg(s). If there is sufficient quantity available, the target price may be the best bid price when selling and the best ask price when buying. The target price may be different than the best price available if there is not enough quantity available at that price or because the target price is an implied price, for example. In other words, current techniques consider whether sufficient quantity is available when determining a lean level, for example. If sufficient quantity is not available at the inside market, for example, quantity available at subsequent price levels away from the inside market may be considered until sufficient quantity is found. As the price(s) of the lean leg(s) changes, the price(s) for the order(s) in the quoting leg(s) may also change to maintain the desired strategy price. Current systems utilize a conservative technique for pricing each of the lean legs to reduce the likelihood of getting “legged.” However, as discussed above, this approach misses untapped potential in the market that could be converted to achieve a better price for the one or more legs specified in the trading strategy.

To enable to a user to alter the way in which the lean prices (e.g., leg prices) of the individual lean legs are calculated, the example configuration interface 500 includes a lean pricing technique parameter 524 and lean pricing technique fields 526, 528 for specifying and/or identifying the lean pricing techniques to be applied to the respective first and second lean legs 502, 504. A lean pricing technique is a specific logic or algorithm (e.g., formula) used to calculate (e.g., determine) a lean price for a lean leg. A lean pricing technique may also be referred to as, for example, a lean technique, a lean pricing principle, a lean pricing specification, a lean pricing mode, a lean pricing rule and/or a lean pricing calculation. In the illustrated example, the lean pricing technique fields 526, 528 include dropdown buttons 530, 532 to present a plurality of selectable lean pricing techniques. Therefore, a trader can select or define which of the lean pricing techniques to associate with each of the first and second lean legs 502, 504. Then, the selected lean pricing techniques are used or applied to the respective lean legs 502, 504 to determine (e.g., calculate, price) lean prices for the respective first and second lean legs 502, 504. In other words, a first lean pricing technique may be used to determine a first lean price (e.g., a first leg price) for the first lean leg 502 and a second lean pricing technique may be used or applied to determine a second lean price (e.g., a second leg price) for the second lean leg 504. In some examples, the lean pricing techniques in each of the dropdown 530, 532 are the same. In other examples, the lean pricing techniques in each of the dropdown menus may be different. Examples of lean pricing techniques may be, for example, a “gap leaning” technique, a “lean level support” technique, a technique considering the quantity available at certain levels and deciding to lean on better levels based on a probability of getting filled, etc. In other examples, other lean pricing techniques may be applied the first and second lean legs 502, 504 that may be based on other types of market conditions such as the last traded price (LTP), the last traded quantity (LTQ), a theoretical value, multiple quantities such as quantities closer to the inside market, or some other reference point.

In some examples, the lean pricing techniques may include parameters that can be used to define the criteria of the respective lean pricing techniques. To enable a user to also modify the parameters associated with each of the lean pricing techniques, the configuration interface 500 includes a parameter window 534. In the illustrated example, the parameter window 534 includes an area designated for each of the respective first and second lean legs 502, 504 and displays any parameters that may be set by the user for the selected lean pricing techniques.

In the illustrated example, once the spread trading strategy is defined, a user may select a button 536 labeled “OK” to accept the spread trading strategy. After selecting the button 536, a spread window and leg windows may be opened (e.g., a leg window for each of the quoting legs and lean legs), as illustrated in FIG. 6 (discussed in further detail herein). A user may instead click a button 538 labeled “CANCEL” to cancel the spread trading strategy.

One example lean pricing technique is the “gap leaning” technique, which is disclosed in U.S. Pat. No. 8,249,977, titled “System and Method for Aggressively Trading a Strategy in An Electronic Trading Environment,” and filed May 28, 2008, which is hereby incorporated by reference in its entirety. In the gap leaning technique described U.S. Pat. No. 8,249,977, a user may select to lean on a price level above or below the best bid/ask price for a lean leg. In particular, the user may choose between a mild, moderate or extremely aggressive lean. For example, if a trader chooses to trade mildly aggressive, then the automated trading tool will quote an order in the lean leg by leaning on one price level above the best bid or one price level below the best ask. If the trader chooses to trade moderately aggressive (e.g., when there is more than one price level within the gap in the market), the automated trading tool will quote the order in the lean leg by leaning on two price levels above the best bid or below the best ask. If the trader chooses to trade extremely aggressive (e.g., when there is more than one price level within the gap in the market), the automated trading tool will quote the order in the lean leg by leaning on one price level below the best ask or one price level above the best bid. Each of the differently levels of aggression offers different benefits and different risks. While there may not be any quantity available at the price levels above the best bid or below the best ask, other traders may be willing to more quickly buy at a higher price or sell at the lower price instead of waiting for the market to move and, thus, the trader can achieve a better price for buying or selling the leg.

In the illustrated example of FIG. 5, the gap leaning technique has been selected in the first lean pricing technique field 526 for the first lean leg 502. As such, when calculating the quote price for the quoting leg, the lean price for the first lean leg 502 will be determined using the gap leaning technique. Further, because the gap leaning technique includes additional parameters that can be specified, the parameters are listed in the parameters window 534. Specifically, in the illustrated example, a first parameter field 540 is provided to enable a trader to choose between mild, moderate or extreme levels of lean aggressiveness. In some examples, the first parameter field 540 includes a dropdown menu of predefined values or choices to choose from. In other examples, the first parameter field 540 may be an empty text box that allows the trader to enter any value. In some examples, a lean pricing technique has more than one parameter associated with the respective lean pricing technique. In such an example, multiple parameter fields are displayed in the parameters window 534, and a trader can similarly modify any of the associated parameters. As mentioned above, in some examples, a lean pricing technique may have no associated parameters. For example, a lean pricing technique may be similar to the moderate approach of the gap leaning technique and always price the lean leg by leaning on two price levels above the best bid or below the best ask. In such an example, the lean pricing technique may have no parameters to specify and, thus, no parameters may be presented in the parameters window 534.

Another example lean pricing technique, referred to as a “lean level support” technique, is disclosed in U.S. Patent Publication No. 2011/0099124, titled “Lean Level Support for Trading Strategies,” and filed Oct. 26, 2009, which is hereby incorporated by reference in its entirety. In the lean level support technique described in U.S. Patent Publication No. 2011/0099124, a price level under consideration as a lean level is determined based at least in part on quantity available at the price level and/or one or more other price levels. For example, a tradable object associated with a lean leg may be considered to be in a “sparse” market, where many of the price levels may not have any quantity available, resulting in gaps in the quantity available at various price levels. In addition, the quantity available at many price levels may be small, possibly being comprised of only a single order. Also, new quantities may become available infrequently, with new orders being placed only occasionally and for small quantities. In such a market, past conservative techniques may expose a trader to unexpected risk, which may lead to significant losses. This is because, if the leaned on quantity were to become unavailable before a quoting order was filled, the next price level with available quantity might be several ticks away. A trader leaning on such a price may then either have to wait for more quantity to become available at that price or find quantity available at a worse price. In the former case the trader would be legged and in the latter case the trader would not achieve the desired strategy price, potentially by a large number of ticks. To overcome this problem, the lean level support technique assesses the support in the pricing level, which may be based on a plurality of different factors. For instance, in one example disclosed in U.S. Patent Publication No. 2011/0099124, a price level may be determined to have support when the needed quantity is less than a percentage (e.g., 10%) of the available quantity at the price level. Many other example parameters for defining and assessing the support in a pricing level are disclosed in U.S. Patent Publication No. 2011/0099124 such as a predefined number of levels into the depth, a predefined number of ticks away from the inside market, a predefined number of ticks into the market, or weighted averages.

In the illustrated example of FIG. 5, the lean level support technique has been selected in the second lean pricing technique field 528 for the second lean leg 504. As such, when calculating the quote price for the quoting leg, the lean price for the second lean leg 504 will be determined using the lean level support technique. In some examples, the lean level support technique may also include parameters that may be set by the user to define how the lean level support technique functions. These parameters can be listed in the parameters window 534. In the illustrated example, a second parameter field 542 is provided to enable a trader to specify a percentage above a needed quantity. For example, 10% has been entered in the second parameter field 542. When determining a lean price for the second leg 504, the lean level support technique will determine if there is sufficient quantity, above 10%, of the quantity needed at the respective price level. For example, if the quantity needed to be bought for the second lean leg 504 is 100, a price level with a quantity of 105 may be determined to have no support because the quantity available of 105 is not at least 10% above the needed quantity of 100. Alternatively, if a price level has an available quantity of 200, it may be determined to have support because it has more than 10% of the needed quantity available.

As disclosed herein, in some examples, a lean pricing technique may have more than one parameter associated with the respective lean pricing technique. In such an example, multiple parameter fields are displayed in the parameters window 534 for the corresponding lean pricing technique, and a trader can similarly modify any of the associated parameters. Alternatively, in some examples a lean pricing technique may have no associated parameters. For example, a lean pricing technique may be similar to the lean level support technique and always require the available quantity to be at least 10% above the quantity needed. In such an example, the lean pricing technique may have no parameters to specify and, thus, no parameters may be presented in the parameters window 534 for the respective lean pricing technique.

In the illustrated example, a first lean pricing technique (e.g., the gap leaning technique) selected for the first lean leg 502 is different than a second lean pricing technique (e.g., the lean level support technique) selected for the second lean leg 504. Thus, unlike previous systems that determined the lean prices based only on sufficient quantity or rigidly applied the same calculation to all the legs, the example configuration interface 500 enables the selection of different lean pricing techniques for each lean leg (e.g., on a per-leg basis). As a result, each of the lean legs can be quoted or priced based on their respective lean pricing techniques, which enables a trader to build a more comprehensive spread trading strategy that may be, for example, more or less conservative (e.g., depending on the trader's strategy). In the case with more lean legs (e.g., four lean legs, eight lean legs, etc.), different lean pricing techniques can likewise be selected and applied to each of the lean legs.

In some examples, the same lean pricing technique or type of lean pricing technique may be selected for both the first and second lean legs 502, 504, but the associated parameters (e.g., sets of parameters) may be different. For example, the lean level support technique may also be selected for the first lean leg 502 (instead of the gap leaning technique) and the trader may input a different percentage in the parameter window 534 for applying the lean level support technique to the first lean leg 502. For example, the trader may specify a percentage of 30% and, thus, the resulting techniques applied to the first and second lean legs 502, 504 are different. Therefore, each of the first and second legs 502, 504 are calculated using a different lean pricing technique (e.g., which is the same technique but defined by different sets of parameters).

In some examples, a plurality of predefined lean pricing techniques are presented to the trader (e.g., via a dropdown menu). The lean pricing techniques can be part of the automated trading tool and/or stored separately in the trader's application. In some examples, a trader may utilize lean pricing techniques provided by the trader (e.g., custom to the trader), the trader's firm, the trader's client, a third party vendor that sells lean pricing techniques, an exchange, etc. In some examples, a trader may have a library of lean pricing techniques and can download additional lean pricing techniques to the library. In some examples, the lean pricing techniques may be completely custom and written by or for the individual user. Additionally or alternatively, in some examples a lean pricing technique may be automatically applied to a lean leg based on a threshold market condition (e.g., defined or set by a user). For example, if the market for a lean leg suddenly fluctuates or changes to a “sparse” market, the automated trading tool may automatically apply a different lean pricing technique to the lean leg. A modified lean price may be determined for the lean leg and the quote price can also be recalculated.

Different lean pricing techniques may be advantageous for different markets, for example. In some examples, a set of (e.g., two or more) lean pricing techniques may be bundled together and applied to other trading strategies. For example, a trader may define a trading strategy where a first lean pricing technique is applied to a first lean leg and a second lean pricing technique is applied to a second lean leg. In another trading strategy, the user may desire to apply the same combination or pair of lean pricing techniques to the two lean legs of the new trading strategy. The user may select to apply the set of lean pricing techniques (e.g., as a bundle), which applies the first lean pricing technique to the first lean leg in the new strategy and the second lean pricing technique to the second lean leg in the new strategy.

In some examples, the trading strategy may change as updated market data is received by, for example, the trading device 110 and/or the gateway 120 of FIG. 1. Market data includes, for example, information about the quantity available at each of a plurality of price levels. At all times, the market data is subject to change as new orders are being received at the exchange (e.g., the exchange 130 of FIG. 1). As the market data for the respective first and second lean legs 502, 504 changes, the lean order prices for the first and second legs 502, 504 can be recalculated (e.g., modified). Then, the quote price can be updated or recalculated. If the quote price has changed, the original submitted quote order can be cancelled and a new quote order with the recalculated order price can be submitted or the original submitted quote order modified to reflect the recalculated quote price.

In some examples, in addition to having a single quoting leg, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized. In such an example, a user may also select a lean pricing technique to be applied to the quoting leg, so when one of the lean legs is being quoted, the other lean legs, including the quoting leg, are priced using their respective lean pricing techniques.

In the illustrated example of FIG. 5, the user may adjust any of the fields (e.g., the contract fields 512, 514, the spread multiplier fields 516, 518, the spread ratio fields 520, 522, the lean technique fields 526, 528 and/or the parameters in the parameter window 534) by selecting (e.g., via a mouse, a stylus, a finger, etc.) the fields and entering a new value and/or selecting a new value from a dropdown menu.

After the spread trading strategy has been defined or configured via the configuration interface 500 of FIG. 5, the spread trading strategy data feeds may be displayed to the user via a trading interface. FIG. 6 illustrates example trading interfaces that may be displayed to the user together or separately. The trading interfaces include a spread window 600 and three leg windows: a quoting leg window 602 for the quoting leg, a first lean leg window 604 for the first lean leg 502 (leg “A”) and second lean leg window 606 for the second lean leg 504 (leg “B”). The example windows 600, 602, 604, 606 may be displayed on, for example, the trading device 110 and/or the trading device 210 of FIGS. 1 and 2 using a trading application including trading tools to process and/or organize market data. Trading tools may include, for example, MD TRADER®, X_TRADER®, ADL®, AUTOSPREADER®, and AUTOTRADER™, each provided by Trading Technologies. In the illustrated example of FIG. 6, the trading interfaces include example values, which are used to illustrate the example methods and systems of defining and implementing a spread trading strategy having multiple lean legs.

The windows 600, 602, 604, 606 may generated upon pressing the “OK” button 536 in FIG. 5, for example. In FIG. 6, the quoting leg window 602 corresponds to the contract for the selected quoting leg, the first lean leg window 604 corresponds to the contract for the first lean leg 502 and the second lean leg window 606 corresponds to the contract for the second lean leg 504. More or fewer windows may be generated and/or displayed depending on the number of legs in the spread trading strategy and/or the user's preferences.

In the illustrated example, the leg windows 602, 604, 606 show the inside market and the market depth for the legs. Although not illustrated in FIG. 6, the spread window 600 would also present the inside market and market depth data of the spread. Columns 608, 610, 612, 614 display the buy quantities and columns 616, 618, 620, 622 display the ask quantities at corresponding price levels shown in columns 624, 626, 628, 630, respectively. The functions and capabilities of the example windows 600, 602, 604, 606 are disclosed in U.S. Pat. No. 7,434,325, which is incorporated by reference above.

Traditionally, for example, a trader may desire to buy the trading strategy, which is defined as buying 10 units (e.g., shares) of the tradeable object for the quoting leg, selling 10 units of the tradeable object for the first lean leg 502 and selling 10 units of the tradeable object for the second lean leg 504. As described herein, traditional approaches for executing a spread trading strategy operate by quoting or pricing the quoting leg based on a desired spread trading strategy price and the price levels of the lean legs at which the lean legs can be filled (e.g., for which there is sufficient quantity). For example, if the desired spread price to buy one unit of the spread is 1010, the price level for the first lean leg 502 is selected at the best bid price with sufficient quantity where 10 units of the first lean leg 502 can be sold, and the price level for the second lean leg is selected at the best bid price with sufficient quantity where 10 units of the second lean leg can be sold. Referring to the first lean leg window 604 for the first lean leg 502, the best price with an available quantity to complete or fill the order is at the price level 49. As illustrated in the second lean leg window 606 for the second lean leg 504, the best price with an available quantity to complete or fill the order is at the price level 52. Thus, the first lean price for the first lean leg 502 is priced or quoted at 49 and the second lean price for the second lean leg 504 is priced or quoted at 52. Selling 10 units of the first lean leg 502 at a price of 49 and selling 10 units of the second lean leg 504 at a price of 52 results in a total sell price of −1010. To complete the spread, the quoting leg is quoted at a price that results in the desired spread trading price of 1010. In this example, the quoting leg is quoted at a price of 202, because buying 10 units at a price of 202 results in buy price of 2020. Thus, the spread between the quoting leg and the two lean legs results in the desired spread trading price of 1010. However, as described herein, this rigid and conservative approach can lead to missed potential for profit.

In contrast, certain example systems and methods disclosed herein enable different lean pricing techniques to be applied to different lean legs. In the example configuration interface 500, for example, the gap leaning technique is selected for the first lean leg 502 and the lean level support technique is selected for the second lean leg 504. For the first lean leg 502, the gap leaning based lean pricing techniques specifies a moderate level of lean aggressiveness. Thus, when this gap leaning technique is applied to the first lean leg 502, the first lean leg is quoted at one price level above the best bid price. Referring to the first lean leg window 604, one price level above the best bid is at a price level of 50. Therefore, the first lean price for the first lean leg 502 is 50. Additionally, in the configuration interface 500, the lean level support technique is selected for the second lean leg 504, and 10% is selected/identified in the parameter window 534. When this lean level support technique is applied to the second lean leg 504, the second lean leg 502 is quoted the best price level with a quantity having at least 10% more quantity available than the needed quantity (e.g., 10 units). Referring to the second lean leg window 606, the best bid price of 52 has an available quantity of 10, which is not at least 10% above the 10 units that are to be sold in the second lean leg 502 as part of the spread trading strategy. The next price level having sufficient quantity is analyzed. The price level of 50 has 20 units available, which is over 10% above the 10 units that are to be sold. Therefore, the second lean price for the second lean leg 504 is 50. Selling 10 units of the first lean leg 502 at a price of 50 and selling 10 units of the second lean leg 504 at a price of 50 results in a total sell price of −1000. To complete the spread and meet the desired spread trading price of 1010, the quoting leg is quoted or priced at a price of 201, because buying 10 units of the quoting leg at 201 equals a price of 2010, which completes the spread. Therefore, if a trader selects to buy 1 unit of the spread at a price level of 1010 (e.g., the desired spread trading price), an order or quote order (e.g., a buy order) is submitted to the exchange for the quoting leg at the quote price of 201. Once the quote order is filled, orders to sell the other two lean legs are sent to the corresponding exchanges in order to complete the spread.

Using the traditional approach, as discussed above, resulted in a quote price of 202, which has no available quantity, as illustrated in the quote leg window 602. Using the example methods and system disclosed herein, however, resulted in a quote price of 201, which does have an available quantity. Therefore, when submitting the quote order for the quoting leg at the price of 201, the quote order may get filled quicker. As a result, the trader is able to buy the spread at the desired value, whereas with the traditional approach the trader may have to adjust the desired spread trading price in order to get filled. After selling the spread, later, at a higher price, the trader may effectively realize a profit that may not have been available using the traditional approach. As illustrated in this example, selecting different lean pricing techniques for different ones of the lean legs affects the lean prices of the lean legs and, thus, the quote price for the quoting leg to complete the spread.

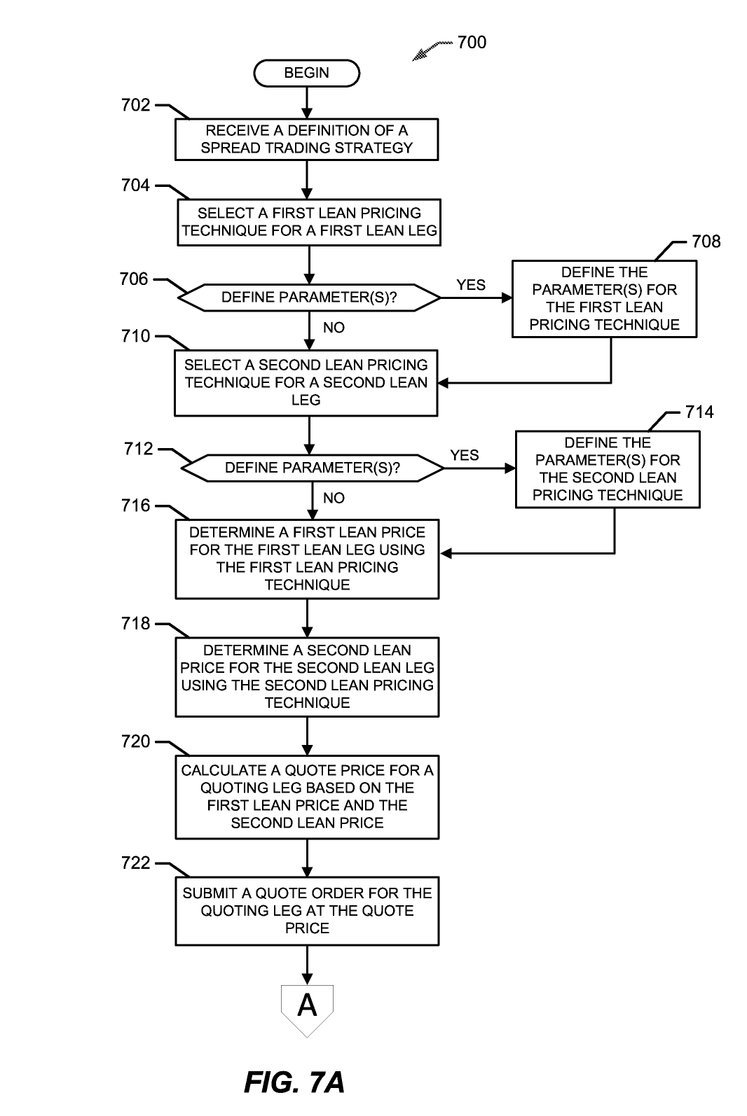

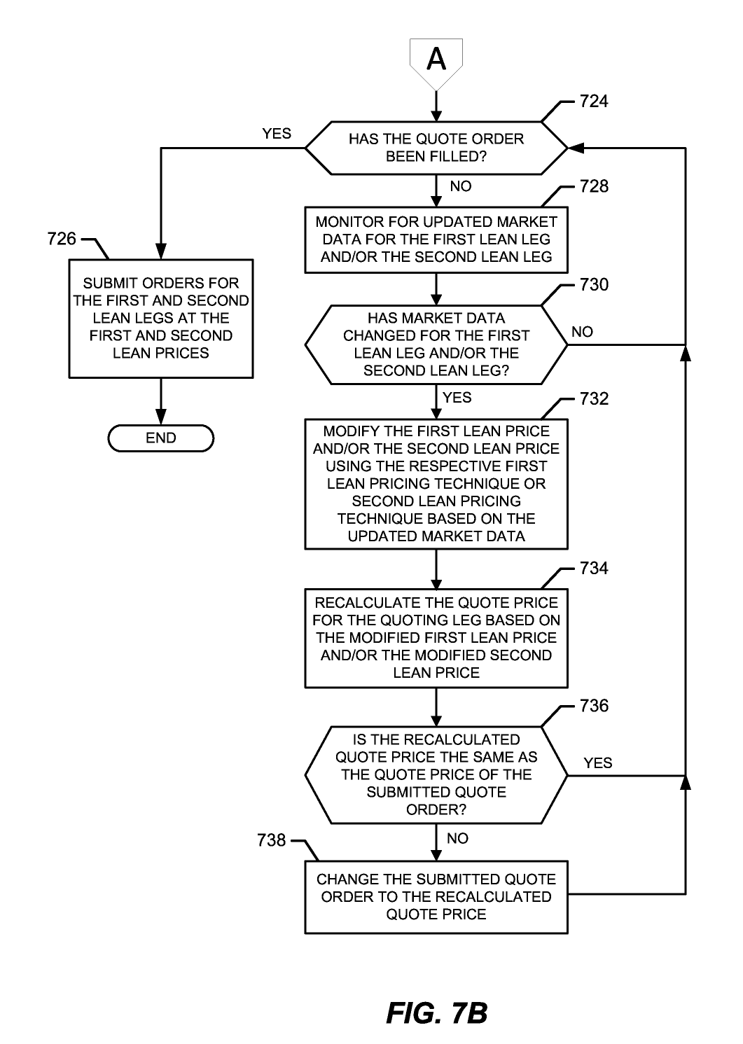

FIGS. 7A and 7B illustrate a flow diagram of an example process or method 700 to define a spread trading strategy having multiple lean legs. The example method 700 includes receiving a definition of a trading strategy or spread trading strategy (block 702). The definition of the spread trading strategy defines which legs of the trading strategy are associated with which tradeable objects. As disclosed herein, a spread trading strategy may have one or more quoting legs and one or more leaning legs, and each of the legs are associated with a tradeable object that is to be bought or sold as defined by the spread trading strategy. The spread trading strategy may be defined using, for example, the configuration interface 500 of FIG. 5. In the configuration interface 500, one or more legs of the spread trading strategy may be selected and the spread setting parameters may also be selected. In the illustrated example of FIG. 5, the first lean leg 502 and the second lean leg 504 have been defined as part of the spread trading strategy.

In some examples, the definition of the spread trading strategy may include lean pricing techniques that are to be applied for each of the lean legs. Therefore, the example method 700 includes selecting a first lean pricing technique for a first lean leg (block 704). As disclosed herein, there are multiple lean pricing techniques that may be used to determine (e.g., calculated, price) a lean price (e.g., a leg price) for the first lean leg. In the example configuration interface 500 of FIG. 5, for example, the first lean pricing technique field 526 is provided to enable a user to specify a lean pricing technique to be applied to the first lean leg 502. A user may interact with an automated trading tool displaying the configuration interface 500 (e.g., on a user interface) to select a lean pricing technique (e.g., from a list of lean pricing techniques a dropdown menu) to be applied to the first lean leg 502.

In some examples, the selection of the first lean pricing technique (block 704) may be performed automatically. For example, if a threshold market condition is reached (e.g., if the market becomes sparse), a predefined lean pricing technique may be automatically selected. For example, the method 700 may include detecting a change in a market condition in the first lean leg and comparing the change in the market condition to a threshold. If the threshold is met (e.g., exceeds the threshold), the first lean pricing technique or another lean pricing technique may be applied to the first lean leg based on the comparison.

The example method 700 includes determining whether the first lean pricing technique includes parameters that are to be defined (block 706). In some examples, a lean pricing technique may have additional parameters that may be selected to define how the lean pricing technique is applied. For example, in U.S. Pat. No. 8,249,977, the gap leaning technique allows a user to select between mildly, moderately and extremely aggressive leaning. If there are parameters that may be defined, the example method 700 includes defining the parameter(s) for the first lean pricing technique (block 708). For example, in the configuration interface 500 of FIG. 5, the parameter window 534 displays parameters that may be selected or modified for the first lean technique and/or the second lean technique.

In the illustrated example of FIG. 7A, the method 700 includes selecting a second lean pricing technique for a second lean leg (block 710). As disclosed herein, there are multiple lean pricing techniques that may be used to determine a lean price for the second lean leg. In the example configuration interface 500 of FIG. 5, for example, the second lean pricing technique field 528 is provided to enable a user to specify a lean pricing technique to be applied to the second lean leg 504. A user may interact with the trading tool displaying the configuration interface 500 (e.g., on a user interface) to select a lean pricing technique (e.g., from a list of lean pricing techniques a dropdown menu) to be applied to the second lean leg 504. In other examples, the selection of the second lean pricing technique may be performed automatically. For example, if a threshold market condition (e.g., a sparse market) is reached, a predefined lean pricing technique may be applied.

The example method 700 includes determining whether the second lean pricing technique includes parameters that are to be defined (block 712). In some examples, a lean pricing technique may have additional parameters that may be selected to define how the lean pricing technique is applied. If there are parameters that may be defined, the example method 700 includes defining the parameter(s) for the second lean pricing technique (block 714). Defining (e.g., selecting, modifying) parameters for the second lean pricing technique may be similar to defining the parameters of the first lean pricing technique in block 708. In some examples, the first lean pricing technique and the second lean pricing technique are the same type of technique (e.g., a “lean level support” technique), but are defined by different parameters or sets of parameters (e.g., mildly aggressive for the first lean pricing technique and moderately aggressive for the second lean pricing technique) and, thus, result in different lean pricing techniques for the first and second lean legs.

The example method 700 includes determining a first lean price (e.g., a first leg price) for the first lean leg using the first lean pricing technique (block 716). The example method 700 includes determining a second lean price (e.g., a second leg price) for the second lean leg using the second lean pricing technique (block 718). Using different lean pricing techniques to price the different lean legs enables a trader to create more complex and targeted trading strategies that allow the trader to achieve a better price for the one or more legs (e.g., and become more profitable) and capitalize on other factors such as the trader's knowledge of the market, volume being traded, market fluctuations and/or the trader's own personal experience. In some examples, the first lean price and/or the second lean price may be at a level with no sufficient quantity available (e.g., in a gap in the market). However, the trader may have knowledge of the market that would allow the trader to become more profitable. The example trading interface of FIG. 6 illustrates how the prices of the lean legs may be altered by implementing different lean pricing techniques to calculate the lean prices.

In the illustrated example, the method 700 includes calculating a quote price for a quoting leg based on the first lean price and the second lean price (block 720). In some examples, the quote price is also based on a desired spread trading strategy price. For example, the spread trading price is a function of the quoting leg, the first lean leg and the second lean leg. If the lean prices of the first and second lean legs are known, and the desired spread trading strategy price is known, the quote price of the quoting leg can be calculated. An example formula for calculating a spread price having n legs is illustrated below.

Spread Price=±Leg 1 (Price)±Leg 2 (Price)± . . . Leg n (Price)

One or more of the legs may be quoting legs and one or more of the legs may be lean legs. In some examples, each of the leg prices is multiplied by a respective multiplier value.

The example method 700 includes submitting a quote order (e.g., to an exchange) for the quoting leg at the quote price (block 722).

In some examples, the definition of the spread trading strategy includes more than two lean legs. In such an example, the method 700 may include selecting lean pricing techniques for the additional lean legs, defining one or more parameters for each of the additional lean pricing techniques (if there are parameter(s) to be defined) and determining lean prices for the additional lean legs. These processes may be performed similar to the processes described above for the first and second lean legs (blocks 704 to 718). In some examples, the same lean pricing technique is applied to two or more of the lean legs. For example, if a third lean leg is defined in the spread trading strategy, a third lean pricing technique may be selected for the third lean leg, and a third lean price for the third lean leg may be determined using the third lean pricing technique. The third lean pricing technique may be the same as the first lean pricing technique, but not the same as the second lean pricing technique. In other examples, a different lean pricing technique is applied to each of the different lean legs. For example, in the case with three lean legs, each of the first, second and third lean pricing techniques may be different (or the same type of lean pricing technique but defined by different parameters). Additionally, the quote price may be calculated based on the additional lean prices for the additional lean legs.

As illustrated in FIG. 7B, the example method 700 continues and determines if the quote order for the quoting leg has been filled (block 724). Once an order is filled at the exchange, for example, a message is sent to the trading device and/or the gateway indicating the order has been filled. If the quote order for the quoting leg is filled, the example method 700 includes submitting orders (e.g., to one or more exchanges) for the first and second lean legs at the first and second lean prices (block 726). The spread trading strategy may be completed once the orders for the first and second lean legs are filled.

If the quote order for the quoting leg has not been filled (block 724), the example method 700 includes monitoring for updated market data for the first lean leg and/or the second lean leg (block 728). Market data may include, for example, information about the quantity available at each of a plurality of price levels. At all times, the market data is subject to change based on the new orders received at the exchange. The example method 700 monitors and detects when, for example, the quantities and/or prices in the different price levels of one of the lean legs has changed. The example method 700 includes determining whether the market data (e.g., available quantities at the different prices levels) for the first lean leg and/or the second lean leg has changed (block 730). If the market data for the first lean leg and the second lean leg has not changed, the example method 700 passes control back to block 724 and again determines if the quote order for the quoting leg has been filled (block 724). Therefore, changes in market data can be continuously monitored.

If the market data for the first lean leg and/or the second lean leg has changed, the example method 700 includes modifying (e.g., recalculating, repricing) the first lean price and/or the second lean price using the respective first lean pricing technique or second lean pricing technique based on the updated market data (block 732). In other words, the first lean price may be modified using the first lean pricing technique based on the updated market information for the first leg and/or the second lean price may be modified using the second lean pricing technique based the updated market information for the second leg. For example, referring to the first lean leg window 604 in FIG. 6, if the best or highest bid price for the first lean leg 502 drops to a price of 48, then the first lean price for the first lean leg 502 is recalculated. In such an example, the gap lean technique provides that the lean price is set at one price level above the best bid price. Therefore, the first lean price will be set at a price of 49, which is one price level above the price level of 48.

In some examples, as disclosed herein, a different lean pricing technique may be automatically applied to a lean leg based on a threshold market condition (e.g., if the market becomes sparse). If the threshold is met, the lean price for the respective lean leg can be modified using the new lean pricing technique.

In the illustrated example of FIG. 7B, the method 700 includes recalculating the quote price for the quoting leg based on the modified first lean price and/or the modified second lean price (block 734). As disclosed herein, the quote price for the quoting leg is calculated based on the lean prices of the lean legs. Thus, if the lean prices of the lean legs change, the quote price for the quoting leg may also change. In some examples, the quote price is also based on a desired spread trading strategy price, which can be defined/selected by the trader.

The example method 700 includes determining if the recalculated quote price is the same as the quote price of the submitted quote order (e.g., the original quote price) (block 736). If the recalculated quote price is different, then the example method 700 includes changing the submitted quote order to the recalculated quote price (block 738). In some examples, this involves canceling the submitted quote order and submitting a new quote order for the quoting leg at the recalculated quote price. In other examples, a message may be sent to the exchange to modify the quoting price of the quote order.

The example method 700 again determines if the quote order (e.g., the original quote order or the altered quote order) for the quoting leg has been filled (block 724). If the quote order has not been filled, then the method 700 may continue monitoring for updated market data for the first lean leg and/or the second lean leg (block 728). If the quote order has been filled, then the method 700 includes submitting the orders for the first and second lean legs at the first and second lean prices (e.g., or the recalculated lean prices). This process of monitoring and updating the lean prices and the quote price may continue until the orders for each of the legs have been filled to complete the spread trading strategy. In some examples, even after the lean leg orders have been submitted, the method may continue to monitor for updated market data and may modify the lean prices of the first and second lean legs in accordance with the respective first and second lean pricing techniques and/or other lean pricing techniques to comply result in the desired spread trading price.

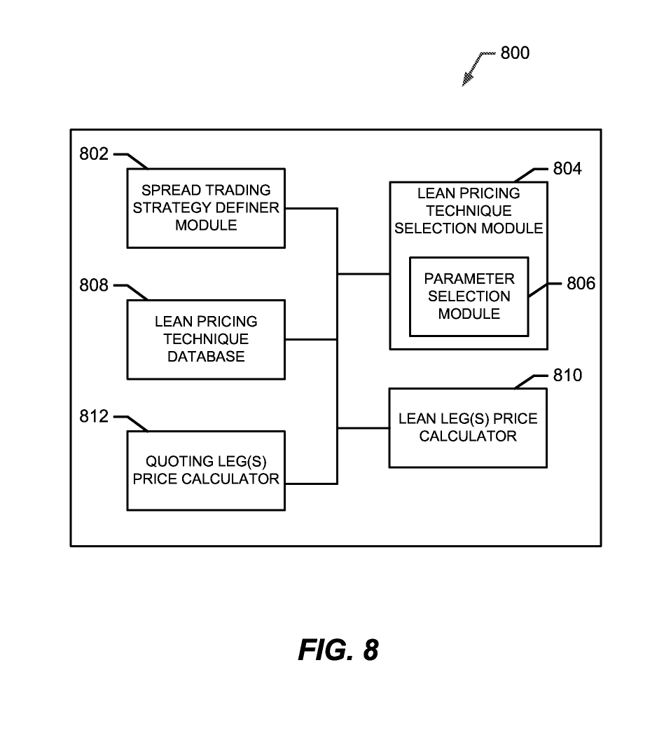

FIG. 8 illustrates a block diagram of an example system 800 that may implement and/or execute the example method of FIGS. 7A and 7B and which may be used to implement, for example, the configuration interface 500 of FIG. 5 and/or the example windows 600, 602, 604, 606 of FIG. 6. In some examples, the system 800 is implemented as part of the trading system 200 of FIG. 2 such as part of software (or an application) associated with the trading device 210 and/or the gateway 220. For example, the system 800 may be implemented as part of an automated trading tool or trading interface used by the trading device 210. In some examples, the system 800 is implemented as computer implemented code or instructions operable independent of software associated with the trading device 210 and/or the gateway 220 of FIG. 2. In some examples, the features and functionality of the system 800 may be implemented in hardware operable in connection with the trading device 210 and/or the gateway 220.

The example system 800 of FIG. 8 includes a spread trading strategy definer module 802 to define a spread trading strategy. As disclosed herein, a definition of a spread trading strategy may include one or more quoting legs and one or more lean legs, where each of the legs is associated with a tradeable object that is to be bought or sold (e.g., at an exchange). In some examples, the spread trading strategy definer module 802 receives the definition from a user who selects the quoting leg(s) and the leaning leg(s). For example, in the configuration interface 500 of FIG. 5, a user may select how many lean legs are to be used and which tradeable objects or contracts are associated with each of the lean legs. In the illustrated example of FIG. 5, the user selected the first lean leg 502 and the second lean leg 504. However, a user may select any number of lean legs (e.g., four lean legs, eight lean legs, thirty lean legs, etc.). Additionally, the user may enter spread setting parameters for the lean legs (e.g., spread ratio, spread multiplier, etc.). In some examples the spread trading strategy definer module 802 also receives a desired spread trading strategy price. For example, the user may select a price and/or quantity at which the user wants to buy or sell the spread. The desired trading strategy price may be selected in a spread window once the legs of the spread trading strategy are configured.

To enable a user to select a lean pricing technique for each of the lean legs, the example system 800 includes a lean pricing technique selection module 804. The user may select a different lean pricing technique for each of the different lean legs and/or may select the same lean pricing technique for some of the legs and not other legs. As disclosed herein, it is advantageous to customize the different lean pricing techniques used to calculate or determine the lean prices for the different lean legs. Previous systems applied a rigid, conservative logic that only priced the lean legs at prices levels that were relatively safe (e.g., were most likely to get filled). However, much potential in different market gaps can be unrealized. Therefore, the lean pricing technique selection module 804 enables a user to select which lean pricing technique to apply to each of the lean legs to calculate the lean prices for the respective lean legs. For example, in FIGS. 5 and 6, the lean level support technique is selected to be applied to the second lean leg 504. As disclosed herein, in some instances, such as trading in a sparse market, the lean level support technique may be beneficial to avoid getting legged. When applied to the second lean leg 504, the second lean price is determined based on the available quantities at the different price levels for the second lean leg 502, as illustrated in FIG. 6.

The example system 800 includes a parameter selection module 806. In the illustrated example, the parameter selection module 806 is part of the lean pricing technique selection module 804. However, in other examples, the parameter selection module 806 may be part of any other module or independent from the other modules. In some examples, a lean pricing technique may have parameters that can be defined. For example, in the gap leaning technique disclosed in U.S. Pat. No. 8,249,977, a user may be able to select between mildly, moderately or extremely aggressive leaning above the best bid or below the best ask. In some examples, the user may be able to specify the parameters associated with the selected lean pricing technique. For example, in the configuration interface 500 of FIG. 5, the lean pricing parameters window 534 lists the categories of parameters associated with a selected lean pricing technique and enables the user to input specific values for the parameters.

In some examples, a user may select the lean pricing technique(s) from a plurality of predefined lean pricing technique techniques (e.g., from a menu of lean pricing techniques presented to the user via the trading interface). In the illustrated example, the system 800 includes a lean technique database module 808 that may be used to store predefined lean pricing techniques. Additionally or alternatively, a user may be able to access other lean pricing techniques from, for example, the user's trading firm, from a third party vendor, from an exchange, etc. In some examples, the lean pricing technique may be completely custom and written by or for the individual user.

The example system 800 includes a lean leg price calculator module 810 to calculate the lean prices for each of the lean legs using the lean pricing techniques that are associated with each of the respective lean legs. The lean leg(s) price calculator module 810 interrogates each of the lean legs to determine which lean pricing technique is to be applied to each of the lean legs. In the illustrated example, the system 800 includes a quoting leg(s) price calculator module 812. The quoting leg(s) price calculator module 812 uses the lean prices, which are determined by the lean leg(s) price calculator module 810, to calculate a quote price for the quoting leg. In some examples, the quoting leg price calculator module 812 also uses the desired spread trading strategy price (e.g., selected by the user) in calculating the quote price. In other words, the quote price is based on (e.g., a function of) the lean prices for the lean legs and the desire spread trading strategy price. Once the quote price is calculated, the system 800 (e.g., or the automated trading tool) can submit an order for the tradeable object of the quoting leg at the calculated quote price.

In some examples, the system 800 also monitors for updated market data for the quoting leg(s) and the lean leg(s). As new orders are received at the exchange, the market data can affect the lean price(s) of the lean leg(s) and the quote price(s) of the quoting leg(s). The lean leg(s) price calculator module 810 can modify (e.g., recalculate) the lean prices for the lean legs based on the updated information using the respective lean pricing techniques. When new lean prices are determined, the quoting leg(s) price calculator module 812 recalculates the quote price based on the modified lean prices. If the recalculated quote price is the same as the quote price of the submitted quote order (e.g., the previously calculated quote order), then the system 800 may do nothing, because the quote price is still effective for completing the spread. However, if the recalculated quote price is different, the system 800 may cancel the previous quote order and place a new quote order at the recalculated quote price. In other examples, the system 800 may send a message to the exchange to update the previous quote order with the recalculated quote price, instead of cancelling the quote order. The example system 800 may continue to monitor for new market information and may constantly update the lean price(s) and the quote price(s).

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, via a computing device, a definition of a spread trading strategy, the definition comprising a first leg associated with a first tradeable object, a second leg associated with a second tradeable object and a third leg associated with a third tradeable object;
determining, via the computing device, a first leg price for the first leg using a first lean pricing technique;
determining, via the computing device, a second leg price for the second leg using a second lean pricing technique, the second lean pricing technique different than the first lean pricing technique;
calculating, via the computing device, a quote price for the third leg based on the first leg price, the second leg price and a desired spread trading strategy price; and
submitting, via the computing device, a quote order for the third leg at the quote price.

2. The method of claim 1 further comprising receiving, via the computing device, a selection from a user on a user interface to apply the first lean pricing technique to the first leg and to apply the second lean pricing technique to the second leg.

3. The method of claim 2, wherein the first lean pricing technique and the second lean pricing technique are selected from a menu of lean pricing techniques presented to the user on the user interface.

4. The method of claim 1, wherein the first lean pricing technique and the second lean pricing technique are a same technique, the first lean pricing technique having a first set of parameters and the second lean pricing technique having a second set of parameters different than the first set of parameters.

5. The method of claim 4 further comprising receiving, via the computing the device, a selection from a user on a user interface to apply the first set of parameters to the first lean pricing technique and to apply the second set of parameters to the second lean pricing technique.

6. The method of claim 1, wherein the definition of the spread trading strategy comprises a fourth leg associated with a fourth tradeable object.

7. The method of claim 6 further comprising:
determining, via the computing device, a third leg price for the fourth leg using a third lean pricing technique, wherein the quote price is based on the third leg price.

8. The method of claim 7, wherein the third lean pricing technique is the same as the first lean pricing technique.

9. The method of claim 7, wherein the third lean pricing technique is different than the first lean pricing technique and the second lean pricing technique.

10. The method of claim 1 further comprising:
receiving, via the computing device, updated market data for the first leg;
modifying, via the computing device, the first leg price using the first lean pricing technique based on the updated market data; and
recalculating, via the computing device, the quote price for the third leg based on the modified first leg price, the second leg price and the desired spread trading strategy price.

11. The method of claim 10 further comprising:
determining, via the computing device, if the recalculated quote price is the same as the quote price of the submitted quote order; and
changing, via the computing device, the submitted quote order to the recalculated quote price if the recalculated quote price and the quote price of the submitted quote order are different.

12. The method of claim 1, wherein the first pricing lean technique is automatically applied to the first leg based on a threshold market condition.

13. The method of claim 1, wherein the first leg price is at a price level without an available bid quantity or an available offer quantity.

14.-39. (canceled)
